(19) United States
(12) Patent Application Publication
(10) Pub. No.: US 2005/0088035 A1
(43) Pub. Date: Apr. 28, 2005

(54) Wheel and wheel rim

(76) Inventors: Jose Henrique Bonaldi, Araras (BR); Evandro Luis Francischeti, Limeira (BR); Sergio Charles Tubero, Sao Paulo (BR); Steven Allan Yollick, Troy, MI (US); Nelson Gosser JR., Piracicaba (BR); Fernando Toshihiko Mitsuyassu, Limeira (BR); Carlos Eduardo Pinotti, Sao Paulo (BR)

Correspondence Address: CARLSON, GASKEY & OLDS, P.C., 400 WEST MAPLE ROAD, SUITE 350, BIRMINGHAM, MI, 48009, US

(21) Appl. No.: 10/930,047

(22) Filed: Aug. 30, 2004

(30) Foreign Application Priority Data
Aug. 28, 2003 (BR) PI0303281-7

(51) Int. Cl. B60B 11/00

(52) U.S. Cl. 301/36.1

(57) ABSTRACT

A wheel is provided with a wheel rim in a single piece that visually corresponds to two ordinary rims joined at their flanges, as well as a wheel rim that integrates this wheel. The wheel, particularly designed for use on vehicles, includes a substantially cylindrical wheel rim and a substantially circular wheel disc associated to each other, the rim having at least two substantially circular and concentric regions and each of the circular regions configuring a groove for positioning a tire. The rim further includes a substantially annular intermediate region provided with at least one radial through bore for ventilation.

This patent application claims priority to Brazilian Patent Application No. PI0303281-7 filed on Aug. 28, 2003.

### BACKGROUND OF THE INVENTION

The present invention relates to a wheel provided with a single-piece wheel rim, which has at least two rims joined at their flanges to position at least two tires.

Heavy utility vehicles, such as trucks and busses, use wheels with a double tire configuration to more effectively distribute heavy loads.

Wheel hubs located on a back shaft (or shafts) of these vehicles have longer studs than conventional ones. The longer length enables the installation of two wheels in a concentric and parallel way, with a first wheel being installed in a conventional position and a second wheel being installed in an opposite way, that is to say, with a disc of the second wheel facing a disc of the first wheel, so that both the first and second wheels face each other. After this step, the first and second wheels are fixed together with wheel nuts, or any other similar attachment.

A great drawback of this known configuration is the manual work required to change of the first and second wheels. If a tire of the first wheel is punctured, a user must remove the second wheel to remove the first wheel. As known, the wheels and tires of middle-size and large-size utility vehicles are considerably heavy, thus it is desirable to eliminate mounting steps.

Another drawback is the fatigue and possible breaking of the studs or even of wheel nuts that secure the wheels, which may occur by shearing if one or more wheel nuts is not correctly tightened.

Several techniques have been developed to address these drawbacks and are described as follows. For example, it is desirable to improve the stability of the vehicle. One way of accomplishing this objective is to increase the contact area of the tires with the ground to improve stability in unfavorable situations like rain, show, etc. for different vehicle types.

U.S. Pat. No. 4,715,660 describes a wheel provided with a rim formed by at least three welded pieces for securing at least two tires. This rim has bores located in a cavity to allow water to exit. The bores provide an additional function of cooling a vehicle brake system.

A great drawback of this design is the amount of welding required to create each rim. Another drawback of this design is wheel rim angulation, which may cause a bending moment and a possible fracture if one tire deflates, which may cause the weight originally supported by two tires to be supported only by one tire.

U.S. Pat. No. 4,135,764 describes a wheel formed by two rims joined by screws, between which is provided a disc having fins (or a ventilator). The disc is fixed by screws between the wheel rims, in the same way as known before. The fins promote air circulation to cool the inside of the wheel.

However, fixing of the two rims by screws increases the wheel cost. Further, screws may fatigue, unscrew, or even possibly break. Another drawback of this design is the possibility of warping or breaking of the fins, which may unbalance the wheel.

U.S. Pat. No. 5,244,026 describes a wheel having a single-piece rim that arranges two tires concentrically with each other. It further has a tube that promotes air communication for calibration between the tires, equalizing tire pressure. This document does not describe any embodiment featuring internal ventilation of wheel brakes, which is highly recommendable for this type of wheel.

Finally, U.S. Pat. No. 4,782,876 describes a wheel, wherein at least two tires are mounted on a single adjacent rim. In this patent, shoulders of the tires rest against each other at a lower portion due to deformation caused by vehicle weight, but are spaced-apart from each other at an upper portion. This feature, however, causes wear of the shoulders and has a tendency for misalignment wheel when one of the tires is more inflated than the other.

### SUMMARY OF THE INVENTION

The present invention has a wheel having a single wheel rim capable of simultaneously supporting at least two tires. Another objective of the present invention is to provide a wheel rim thus configured.

These objectives are achieved by providing a wheel having a substantially cylindrical wheel rim and a substantially circular wheel disc. the wheel rim has at least two substantially circular regions, concentric with each other, with each circular region having a groove for positioning a tire. The rim further has a substantially annular intermediate region, provided with at least one radial through-bore for ventilation.

The present invention has many advantages. The installation of two tires on a single wheel rim considerably increases the tire contact area with the ground, which increases the vehicle stability and braking capacity. Further, if one of the tires deflates, the other will support the vehicle, until the deflated tire can be repaired. Another advantage is that removal of the wheel with the two tires requires a single step. Also, the wheel may be used on any type of vehicle including light-weight and heavy-weight vehicles.

### BRIEF DESCRIPTION OF DRAWINGS

The present invention will now be described with reference to the drawings:

FIG. 1 is a schematic cross-section view of a first preferred embodiment of the wheel of the present invention;

FIG. 2 is a schematic cross-section view of a second preferred embodiment of the wheel of the present invention;

FIG. 3 is a first perspective view of the wheel of the present invention;

FIG. 4 is a second perspective view of the wheel of the present invention;

FIG. 5 is a third perspective view of the wheel of the present invention; and

FIG. 6 is a side view of the wheel of the present invention.

### DETAILED DESCRIPTION OF THE PREFERRED EMBODIMENT

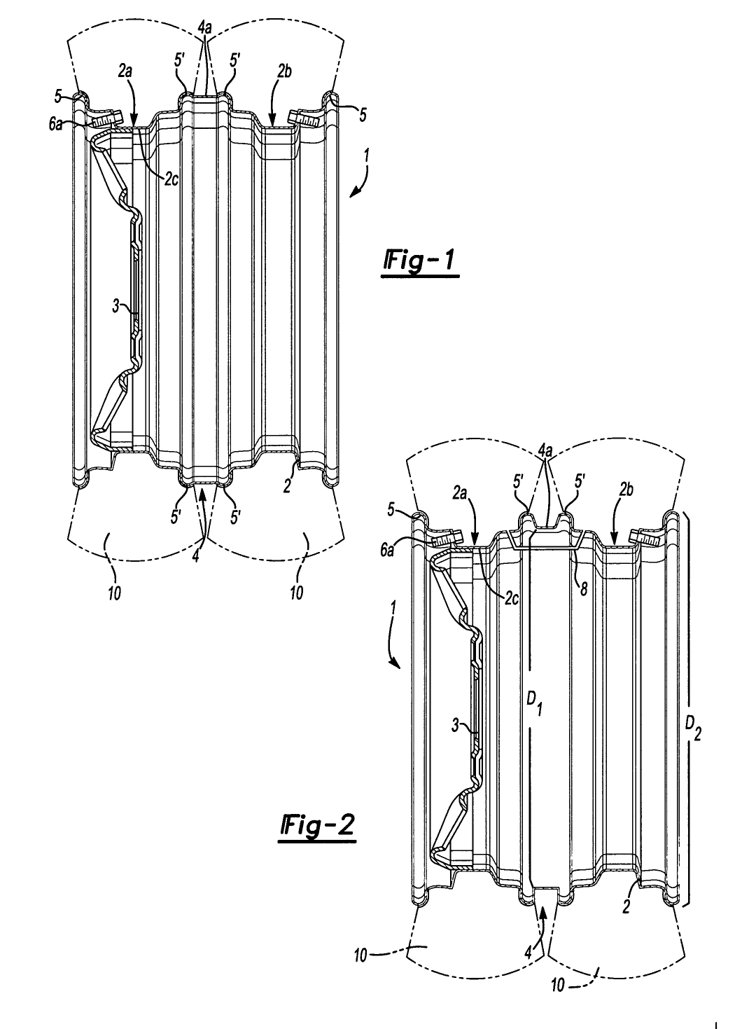

As can be seen from FIG. 1, the wheel 1 has a substantially cylindrical wheel rim 2 and a substantially circular wheel disc 3, associated with each other. The wheel rim 2 may have other shapes than cylindrical, such as a frusto-conical shape. The association between the disc 3 and the wheel rim 2 may be any main association, because this association is not the objective of the present invention. Also, the present invention may provide a wheel cast from light-metal alloy, wherein the wheel rim 2 and the disc 3 do not exist as isolated elements.

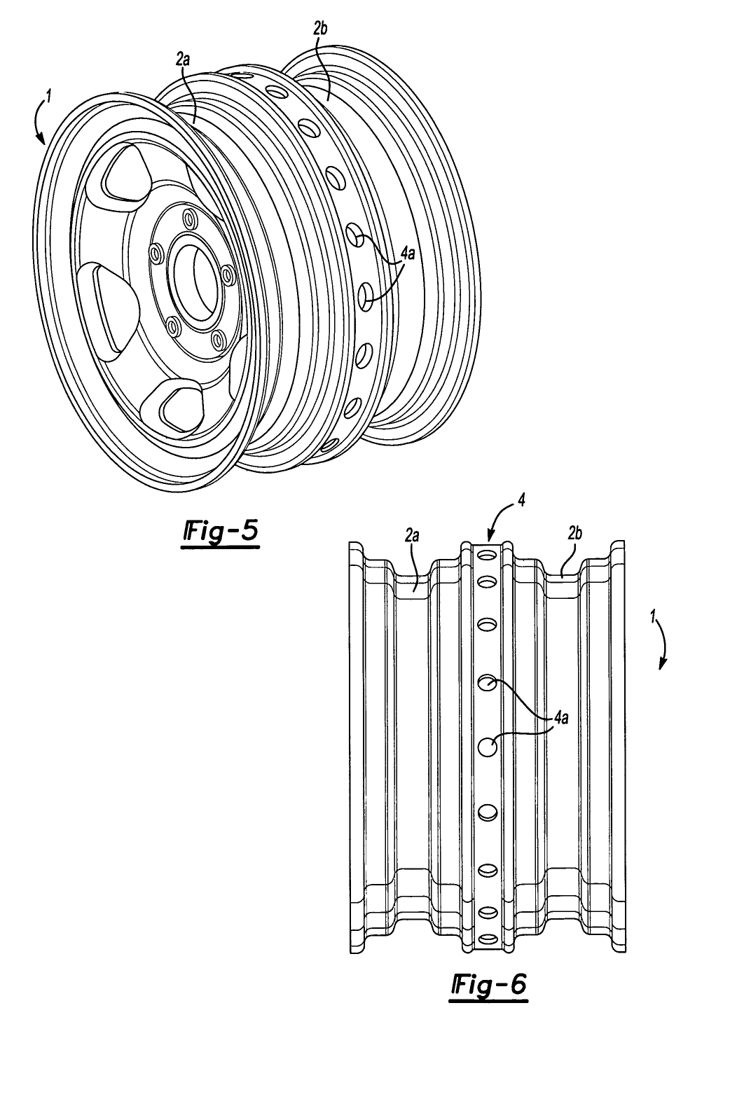

In the preferred embodiments of the present invention, illustrated in FIGS. 1 to 6, disc 3 and wheel rim 2 are made of carbon steel, rolled and stamped, respectively. However, it is evident that they may be made of any other necessary or desirable material, shaped by any known mechanical shaping process.

The wheel rim 2 of the present invention may be provided in a single piece and comprises at least two substantially circular and concentric projecting regions 2a, 2b, each one of the circular and concentric projecting regions 2a, 2b forming a groove for positioning a tire 10. The groove is bounded by respective first flanges 5 and second flanges 5′ of the wheel. Therefore, the wheel rim 2 has four wheel flanges. Two first flanges 5 are located in axial end regions of the wheel rim 2 while two second flanges 5′ are located at an annular intermediate rim portion 4, which will be discussed later.

As widely known to those skilled in the art, the first flanges 5 and the second flanges 5′ form supports for fixing the tire 10 onto the wheel 1 and are preferably J-shaped. Additionally, the first flanges 5 and the second flanges 5′ are used for fixing wheel-balancing weights.

Each circular and concentric projectioning region 2a, 2b has an intermediate rim portion 4 that defines a minimum projection in respect to the rest of the wheel rim 2. In the figures, this portion of minimum projection is indicated at 2c and is the region of wheel rim 2 where an internal diameter is at a minimum.

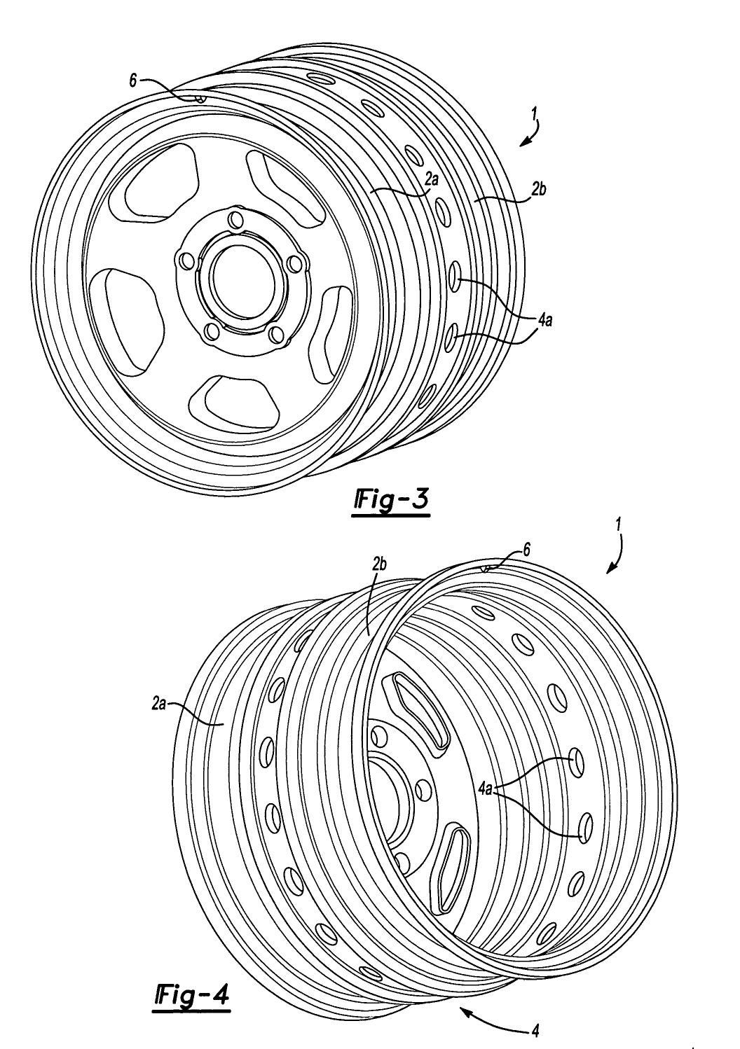

Additionally, each one of the circular and concentric projecting regions 2a, 2b is provided with at least one opening 6 (see FIGS. 3 and 4) for positioning at least one valve 6a for calibration and maintenance of a tire's air pressure, which will be described in greater detail later.

In the illustrated preferred embodiments of the wheel 1, the disc 3 is fixed to the wheel rim 2 at the portion 2c of one of the circular and concentric projecting regions 2a, 2b, but it is evident that this portion 2c may be located in any other region thereof.

The wheel rim 2 further comprises an annular intermediate rim portion 4, already mentioned, arranged between the two circular and concentric projecting regions 2a, 2b, and which is concentric therewith. The annular intermediate rim portion 4 is provided with at least one, but preferably a plurality of radial through ventilation bores 4a, arranged throughout the annular intermediate rim portion 4, preferably equidistant from each other.

The ventilation bores 4a have two main functions, namely, enhancing wheel appearance and bringing about ventilation of an inner port of wheel 1 and, consequently, of a vehicle brake system. Preferably, the ventilation bores 4a are annular in shape, but it is evident that they may be of any other shape, or arranged in another manner in the annular intermediate rim portion 4.

A wheel's inside ventilation is improved with the existence of the ventilation bores 4a, which thereby increase the vehicle brake system's efficiency. Moreover, the ventilation bores 4a provide water flow in flooded regions, or even in rainy weather. Additionally, the ventilation bores 4a prevent salt water accumulation that exists on highways in cold-weather areas, when the salt is thrown onto ice to melt it. The combination of salt with molten ice is highly corrosive and, if accumulated, might corrode the wheel 1 in a short time.

The wheel 1 has a great aesthetic appeal because the ventilation bores 4a provide a different and aggressive (sportive) design desired by a number of consumers, such as those who like sports vehicles.

The wheel 1 has characteristics that favor use on sports vehicles. Because the wheel 1 uses two tires, the wheel 1 enhances the region of contact of the vehicle with the ground. The ventilation bores 4a further improve cooling of brakes and thus are optimized in situations of intensive use, such as the constant use of the brakes at high speeds. In this way, the loss of efficiency of the brakes due to rises in temperature (fading) is greatly decreased.

The wheel 1 also offers advantages to commercial vehicles because of the enlargement of contact area of the tires 10 with the ground. This enlargement is important since the loading capacity per shift (division of the same weight between two tires, which thereby can bear heavier weights) is increased. The brake system is more reliable due to the improvement of cooling, which is very important as commercial vehicles carry heavy weight, which subjects the brakes to heavy use.

Additionally, off-road vehicles also benefit from wheel 1, because the use of two tires with spikes on their shoulders on the same wheel 1 doubles the traction power of the vehicle, greatly improving its efficiency.

Also, as shown in FIG. 2, wheel 1 may have an intermediate rim portion 4′ having a smaller diameter D₁ with respect to the first flanges 5, which have a diameter D₂. This configuration forms a region of radial recess with respect to the first flanges 5. This second configuration brings some functional benefits for the wheel 1, such as an increase in resistance resulting from creases caused by the recess of the intermediate rim portion 4′.

It should further be noted that in both configurations, the intermediate rim portions 4, 4′ project from the second flange 5′ as far as the second flange 5′ in the central region of the wheel rim 2.

As already discussed, each one of the circular and concentric projecting regions 2a, 2b is provided with at least one opening 6 for positioning at least one valve 6a for calibration and maintenance of a tire's air pressure. The openings 6 are circular in shape, but they may be of any other shape depending upon the shape of the valve 6a.

In a first preferred embodiment of the wheel 1, each one of the circular and concentric projecting regions 2a, 2b has an opening 6 for installation of a valve 6a, the latter being independent of each other.

Other situations may be foreseen, as for example, circular and concentric projecting regions 2a, 2b may be provided with one opening 6 for a valve 6a and another opening 6 for connecting a pressure equalizing device 8, as for example a tube, for one of the openings 6 of the other circular and concentric projecting regions 2a, 2b (generically represented in FIG. 2).

This connection between the two circular and concentric projecting regions 2a, 2b makes possible that, when one valve 6a is filled along with the inside of one of the tires 10, the other tires 10 may also be calibrated. Another advantage is that, if a tire 10 loses some pressure, the other tire 10 will make up for this loss with its own internal air, equalizing pressure.

The wheel 1 of the present invention can be quickly changed without needing to remove one wheel at a time, which occurs with today's vehicles, as already mentioned. The present invention further provides the advantage that, if one tire 10 deflates, the other tire 10 can support the additional weight until the deflated tire is replaced.

The present invention has a number of advantages. Installing two tires 10 on a single wheel rim 2 improves vehicle stability. Because of the increase in the contact area of the vehicle with the ground, stability and traction are also increased. Moreover, if one tire 10 deflates, the other tire 10 will provide sufficient support until the tire can be replaced. Further, the wheel 1 together with tire 10 may be removed in a single step for a replacement or maintenance as need for light and heavy vehicles. This is a very important feature in utility vehicles, because, as already mentioned, the wheels 1 and tires 10 of this kind of vehicle have a large mass and the removal of the entire two-tire assembly eliminates repeated steps of replacement.

There is also a cooling increase in the vehicle brake system equipped with this wheel 1. Additionally, the appearance of the wheel 1 is attractive, increasing its penetration potential into the consumer market. It is also inexpensive to make, costing virtually the same as that of an ordinary wheel made of stamped steel.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

1. A wheel comprising:
a rim having a first groove for receiving a first tire and a second groove for receiving a second tire;
said rim having a first outer portion including said first groove and a second outer portion including said second groove with an intermediate rim portion being positioned between said first outer portion and said second outer portion; and
at least one ventilation bore extending through said intermediate rim portion, wherein said first outer portion, said second outer portion, and said intermediate portion are formed together as a single piece.

2. The wheel of claim 1 wherein said at least one ventilation bore comprises a plurality of ventilation bores arranged equidistant from each other across said intermediate rim portion.

3. The wheel of claim 1 wherein said at least one ventilation bore is annular in shape.

4. The wheel of claim 1 wherein said rim has a first outer flange spaced from a first inner flange, said first groove defined by said first outer flange and said first inner flange, said rim has a second outer flange spaced from a second inner flange, said second groove defined by said second outer flange and said second inner flange, said first inner flange and said second inner flange positioned between said first groove and said second groove, said first inner flange and said second inner flange supporting said intermediate rim portion extending between said first inner flange and said second inner flange.

5. The wheel of claim 4 wherein one of said first outer flange and said first inner flange has a first diameter and said intermediate rim portion has a second diameter, said first diameter being larger than said second diameter.

6. The wheel of claim 1 wherein at least one of said first groove and said second groove includes an opening for receiving a tire valve.

7. The wheel of claim 1 including a wheel disc mounted to an interior portion of said rim.

8. The wheel of claim 1 including a pressure equalizing device extending from said first groove to said second groove.

9. A wheel comprising:
a rim having a first groove for receiving a first tire and a second groove for receiving a second tire;
said rim having a first inner flange defining said first groove;
said rim having a second inner flange defining said second groove, said first inner flange and said second inner flange being positioned between said first groove and said second groove;
one of said first inner flange and said second inner flange supporting an intermediate member positioned between said first inner flange and said second inner flange; and
at least one ventilation bore extending through said intermediate member.

10. The wheel of claim 9 wherein said at least one ventilation bore comprises a plurality of ventilation bores arranged equidistant from each other across said intermediate member.

11. The wheel of claim 9 wherein said at least one ventilation bore is annular in shape.

12. The wheel of claim 9 wherein said first inner flange and said intermediate member extend circumferentially around said rim, said first inner flange having a first diameter and said intermediate member having a second diameter, said first diameter being greater than said second diameter.

13. The wheel of claim 9 wherein at least one of said first groove and said second groove includes an opening for receiving a tire valve.

14. The wheel of claim 9 including a wheel disc mounted to an inner surface of said rim.

15. The wheel of claim 9 including a pressure equalizing device extending from said first groove to said second groove.

16. A wheel comprising:
a rim having a first groove for receiving a first tire and a second groove for receiving a second tire;
said rim having a first inner flange defining said first groove;
said rim having a second inner flange defining said second groove, said first inner flange and said second inner flange positioned between said first groove and said second groove;
one of said first inner flange and said second inner flange supporting an intermediate member extending between said first inner flange and said second inner flange; and
at least one ventilation bore extending through said intermediate member, wherein said one of said first inner flange and said second inner flange is formed as a single piece with said intermediate member.

17. The wheel of claim 16 wherein said one of said first inner flange and said second inner flange is formed as a single piece with said intermediate member without welding.

18. The wheel of claim 16 wherein both said first inner flange and said second inner flange are formed as said single piece with said intermediate member.
